(19) United States
(12) Patent Application Publication
(10) Pub. No.: US 2005/0079900 A1
(43) Pub. Date: Apr. 14, 2005

(54) STRUCTURE OF A FOLDER-STYLE MOBILE PHONE

(76) Inventor: Han-Yu Li, Tao-Yuan Hsien (TW)

Correspondence Address: NORTH AMERICA INTERNATIONAL PATENT OFFICE (NAIPC), P.O. BOX 506, MERRIFIELD, VA, 22116, US

(21) Appl. No.: 10/708,458

(22) Filed: Mar. 4, 2004

(30) Foreign Application Priority Data
Oct. 9, 2003 (TW) 092128169

(51) Int. Cl. H01R 13/44; H01R 13/60

(52) U.S. Cl. 455/575.3; 455/575.1

(57) ABSTRACT

A mobile phone includes a first housing including a first rotating component with a first slit, a display panel installed on the first housing, a second housing comprising a second rotating component with a second slit and connected to the first rotating component, wherein a plurality of buttons is installed on the second housing for inputting button signals, a flexible printed circuit (FPC) with a first end stretching from the first slit and a second end stretching from the second slit, a third housing connected to the first housing, and a fourth housing connected to the second housing.

### BACKGROUND OF INVENTION

1. Field of the Invention

The present invention relates to a mobile phone, and more specifically, to a folder-style mobile phone having an improved structure of flexible printed circuit (FPC) connected between a liquid crystal display (LCD) module and a main module of the mobile phone.

2. Description of the Prior Art

In the modern information-oriented society, compact and portable mobile phones are widely used as a means of daily communication among people for exchanging information and opinions as well as experiences. As technology progresses, mobile phones are becoming smaller in size, meaning that the limited area needs to be effectively used. In addition, the modules and parts need to be fixed to the mobile phone tightly in order to function normally.

A large proportion of mobile phones are folder-style. A folder-style phone is divided into two parts one part containing a display and the other part a keypad. The two parts are connected with a hinge and other fixing components.

Please refer to FIG. 1 showing a block diagram of a conventional mobile phone 10. The mobile phone 10 has a first housing 12 and a second housing 14. The first housing 12 has a first hinge 16, and the second housing 14 has a second hinge 18. The first hinge 16 is connected to the second hinge 18 by a fixing component so that the first housing 12 along with the second housing 14 can be opened and closed by rotating the hinge. The mobile phone 10 further includes a processing module 20 installed in the second housing 14 for controlling the operation of the mobile phone 10, a radio module 22 installed in the second housing 14 and electrically connected to the processing module 20 for receiving radio signals to generate corresponding communication signals and sending them to the processing module 20 as well as outputting data from the processing module 20 wirelessly, a microphone 24 installed in the second housing 14 and electrically connected to the processing module 20 for converting real sound into audio signals and sending them to the processing module 20, and a plurality of buttons 25 for inputting button signals.

The mobile phone 10 further includes a signal processing module 26 installed in the first housing 12, a display panel 28 installed in the first housing 12 and electrically connected to the signal processing module 26 for displaying data from the signal processing module 26 as an image, a speaker 30 installed in the first housing 12 and electrically connected to the signal processing module 26 for converting the data from the signal processing module 26 into real sound, and a vibrator 32 installed in the first housing 12 and electrically connected to the signal processing module 26 for vibrating the mobile phone when receiving a vibration signal from the signal processing module 26. The mobile phone 10 further includes an FPC 34 with one end connected to the signal processing module 26 and the other end connected to the processing module 20. The FPC 34 passes through a slit in the first hinge 16 and a slit in the second housing in order to connect the processing module 20 with the signal processing module 26 so that the devices and modules in the first housing 12 and the second housing 14 can exchange signals and data with each other.

Please refer to FIG. 2 to FIG. 4, which show how the FPC 34 is installed into the first housing 12 and the second housing 14 of the mobile phone 10. First, the FPC 34 is fixed onto the first housing 12 of the mobile phone 10 so that the lower end of the FPC 34 passes through the slit in the first hinge 16. The lower end of the FPC 34 is then passed through the slit in the second housing 14. Since the first hinge 16 is connected to the second hinge 18 by the fixing component so that the first housing 12 along with the second housing 14 are opened and closed by rotating the hinge, the FPC 34 will bend according to the rotation of the hinge.

However, for the sake of good design, the slit should be n a region covered by the first hinge 16 or the second housing 14 during the rotation, otherwise it will be seen. Such a structure that does not follow good design is not proper for a mobile phone with an exposed hinge because the slit in the hinge may also be exposed when opening the mobile phone.

### SUMMARY OF INVENTION

It is therefore a primary objective of the present invention to provide a folder-style mobile phone having a flexible printed circuit (FPC) of improved structure connected between a liquid crystal display (LCD) module and a main module of the mobile phone in order to solve the problems mentioned above.

Briefly summarized, a mobile phone includes a first housing comprising a first rotating component with a first slit, a display panel installed on the first housing, a second housing comprising a second rotating component with a second slit and connected to the first rotating component, wherein a plurality of buttons is installed on the second housing for inputting button signals, a flexible printed circuit (FPC) with a first end stretching from the first slit and a second end stretching from the second slit, a third housing connected to the first housing, and a fourth housing connected to the second housing.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block diagram of a conventional mobile phone.

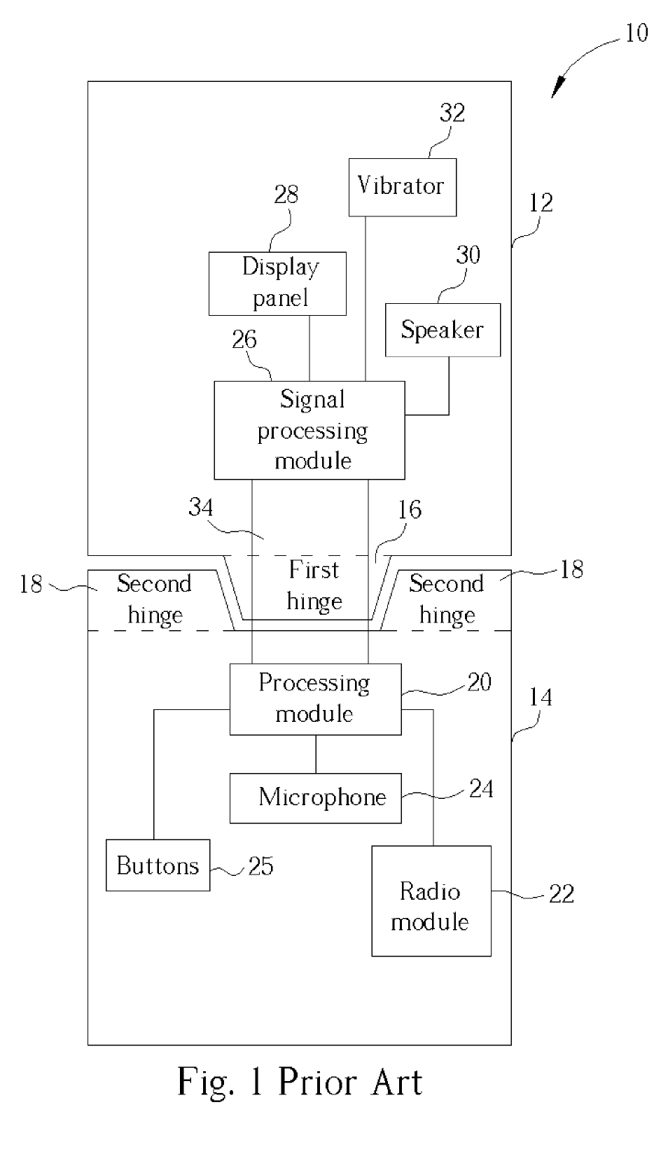

FIG. 2 is a diagram illustrating the first step of how an FPC is installed into the first housing and the second housing of the conventional mobile phone.

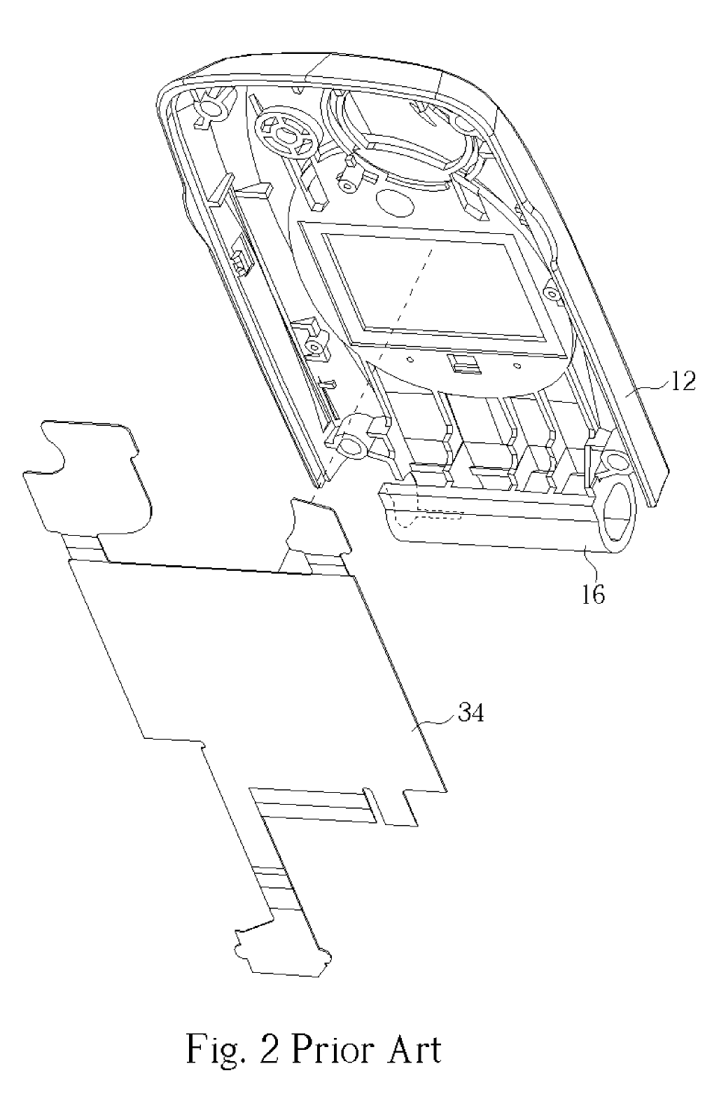

FIG. 3 is a diagram illustrating the second step of how the FPC is installed into the first housing and the second housing of the conventional mobile phone.

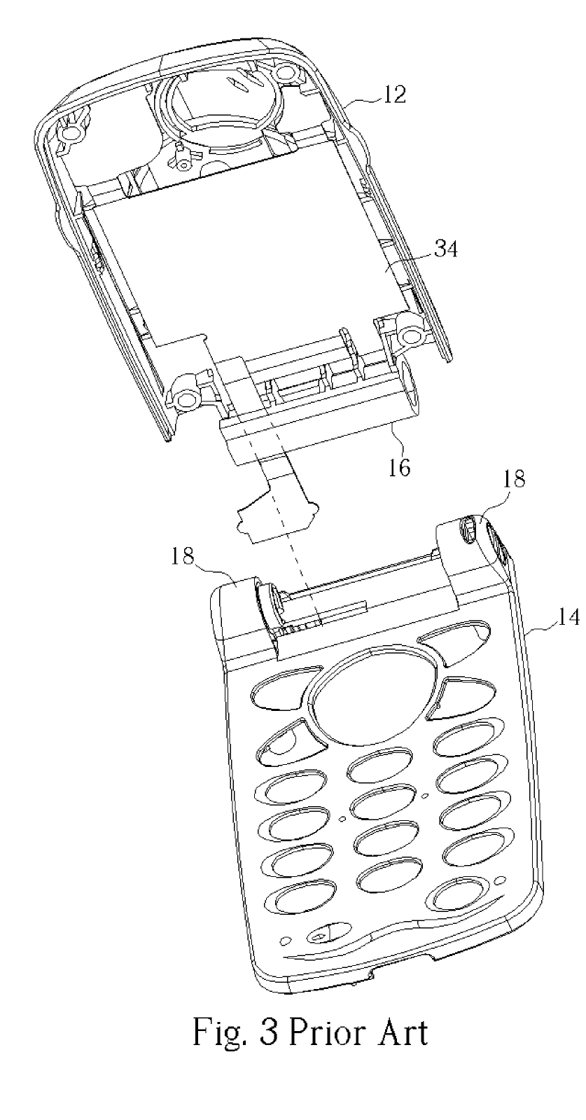

FIG. 4 is a diagram illustrating the FPC installed into the first housing and the second housing of the conventional mobile phone.

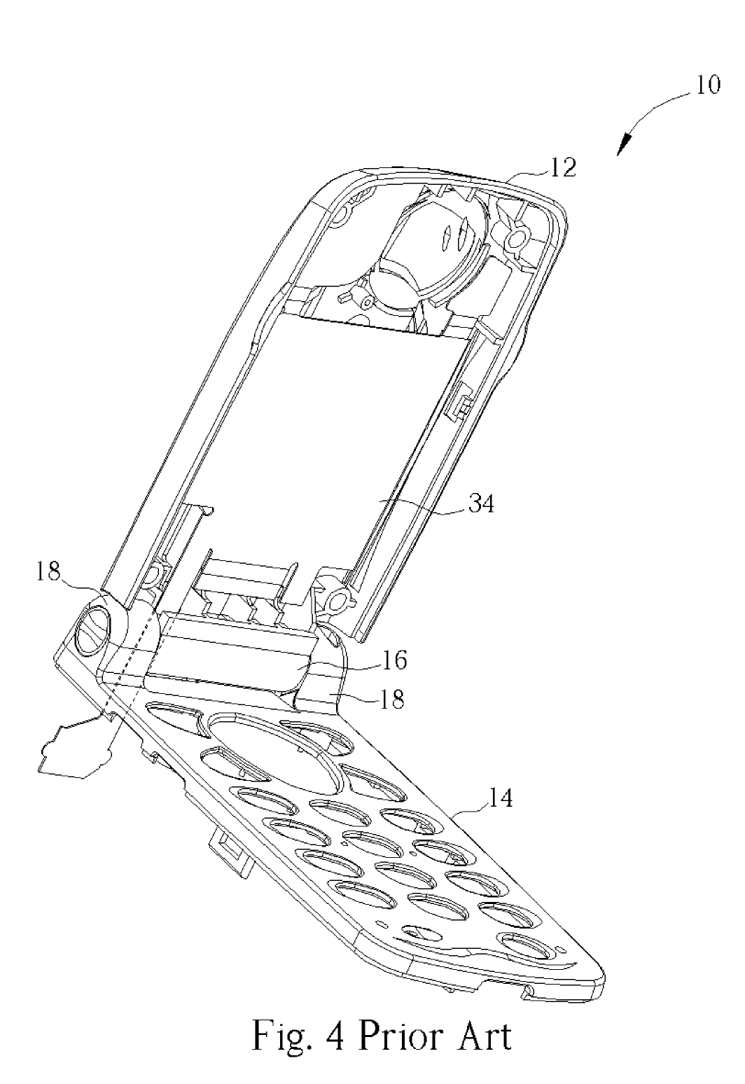

FIG. 5 is a block diagram of a mobile phone according to the present invention.

FIG. 6 illustrates the structure of a first housing of the mobile phone according to the present invention.

FIG. 7 illustrates the structure of a second housing of the mobile phone according to the present invention.

FIG. 8 illustrates how to install a rotating axis into a first rotating component according to the present invention.

FIG. 9 illustrates how to connect the first rotating component to the second housing according to the present invention.

FIG. 10 illustrates how to install an FPC into a first slit of the first rotating component and a second slit of a second rotating component according to the present invention.

FIG. 11 illustrates the first rotating component rotated after installing the FPC into the first slit of the first rotating component and the second slit of the second rotating component according to the present invention.

FIG. 12 illustrates how to assemble the first housing along with the first rotating component to the second housing according to the present invention.

FIG. 13 illustrates how to assemble a processing module and a signal processing module respectively to the second housing and the first housing.

FIG. 14 illustrates all the housings of the mobile phone assembled together.

### DETAILED DESCRIPTION

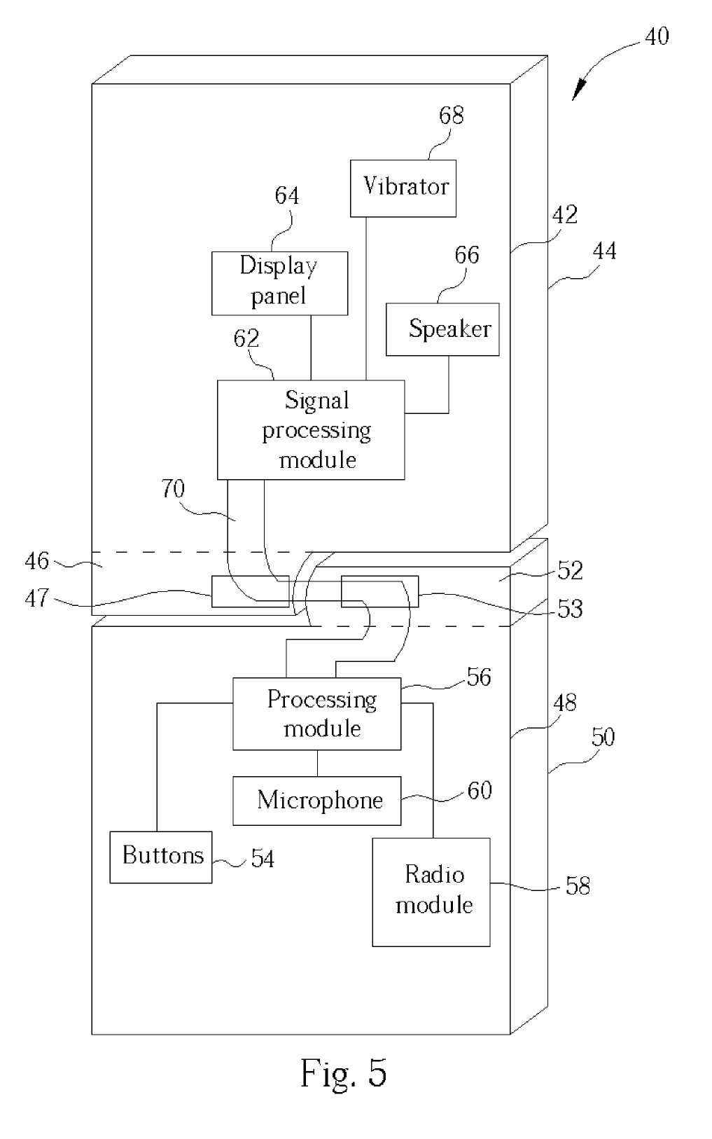

Please refer to FIG. 5 showing a block diagram of a mobile phone 40 according to the present invention. The mobile phone 40 has a first housing 42 and a third housing 44. The first housing 42 has a first rotating component 46 with a first slit 47 in it, and the third housing 44 is connected to the first housing 42. The mobile phone 40 further includes a second housing 48 and a fourth housing 50. The second housing 48 has a second rotating component 52 with a second slit 53 in it and connected to the first rotating component 46, and a plurality of buttons 54. The fourth housing 50 is connected to the second housing 48.

The mobile phone 40 further includes a processing module 56 installed in the second housing 48 and the fourth housing 50 for controlling the operation of the mobile phone 40, a radio module 22 installed in the second housing 48 and the fourth housing 50 and electrically connected to the processing module 56 for receiving radio signals to generate corresponding communication signals and sending them to the processing module 56 as well as outputting data from the processing module 56 wirelessly, and a microphone 60 installed in the second housing 48 and the fourth housing 50 and electrically connected to the processing module 56 for converting real sound into audio signals and sending them to the processing module 56. The mobile phone 40 further includes a signal processing module 62 installed in the first housing 42 and the third housing 44, a display panel 64 installed in the first housing 42 and the third housing 44 and electrically connected to the signal processing module 62 for displaying data from the signal processing module 62 as an image, a speaker 66 installed in the first housing 42 and the third housing 44 and electrically connected to the signal processing module 62 for converting the data from the signal processing module 62 into real sound, and a vibrator 68 installed in the first housing 42 and the third housing 44 and electrically connected to the signal processing module 62 for vibrating the mobile phone when receiving a vibration signal from the signal processing module 62. The mobile phone 40 further includes an FPC 70 with a first end stretching from a first slit 47 of the first housing 42 and connected to the signal processing module 62, and a second end stretching from a second slit 53 of the second housing 48 and connected to the processing module 56 so that the devices and modules in the first housing 42 along with the third housing 44 and the second housing 48 along with the fourth housing 50 can exchange signals and data with each other.

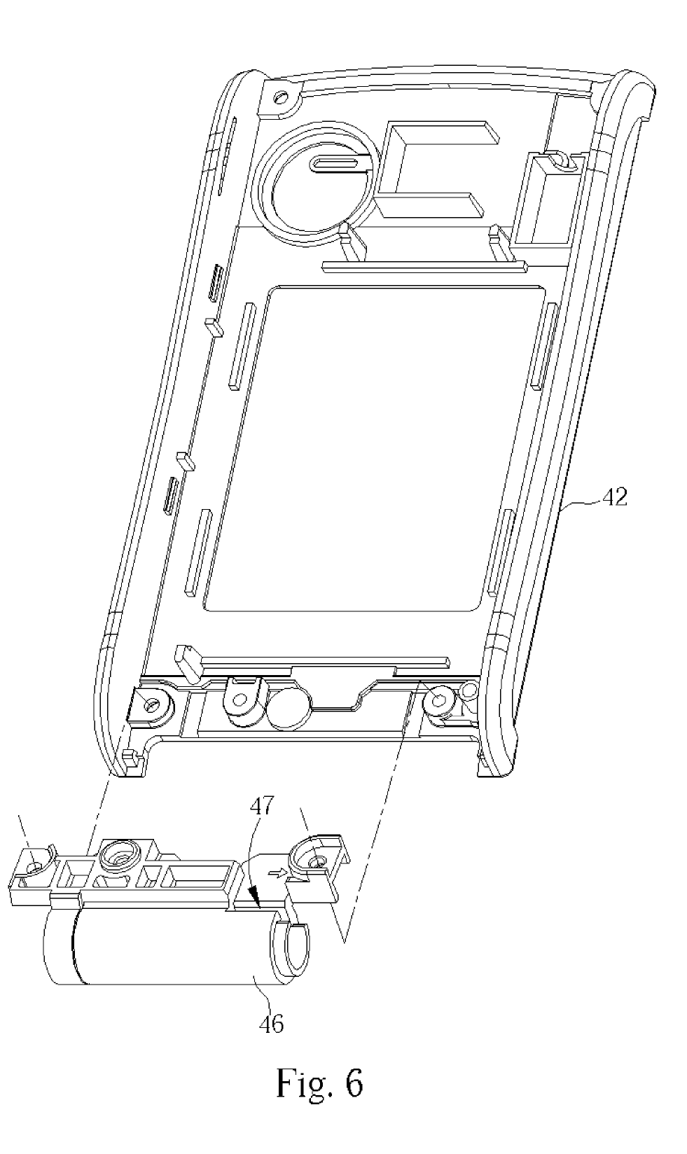

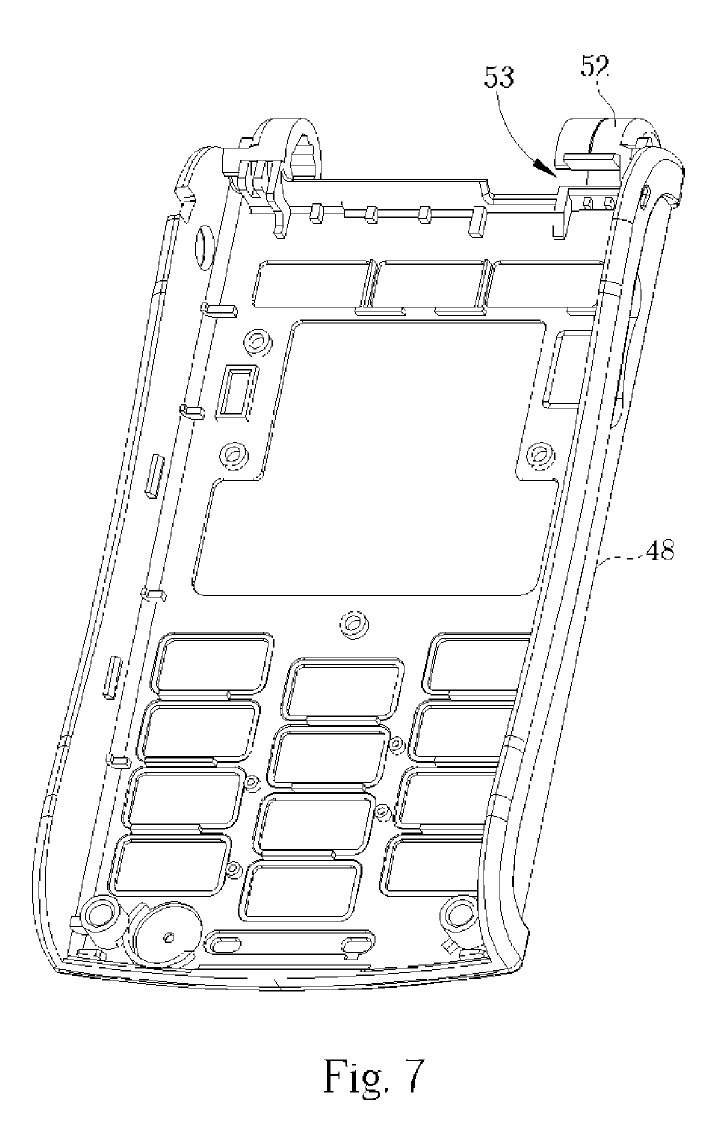

Please refer to FIG. 6 showing the structure of the first housing 42 of the mobile phone 40, and FIG. 7 showing the structure of the second housing 48 of the mobile phone 40. The first housing 42 has a hole for installing the speaker 66 and a hole for installing the display panel 64. The first rotating component 46 of the first housing 42 is screwed to the first housing 42 and has a first slit 47. The second housing 48 has a hole for installing the buttons 54 and a hole for installing the microphone 60. The second rotating component 52 of the second housing 48 is screwed to the second housing 48 and has a second slit 53.

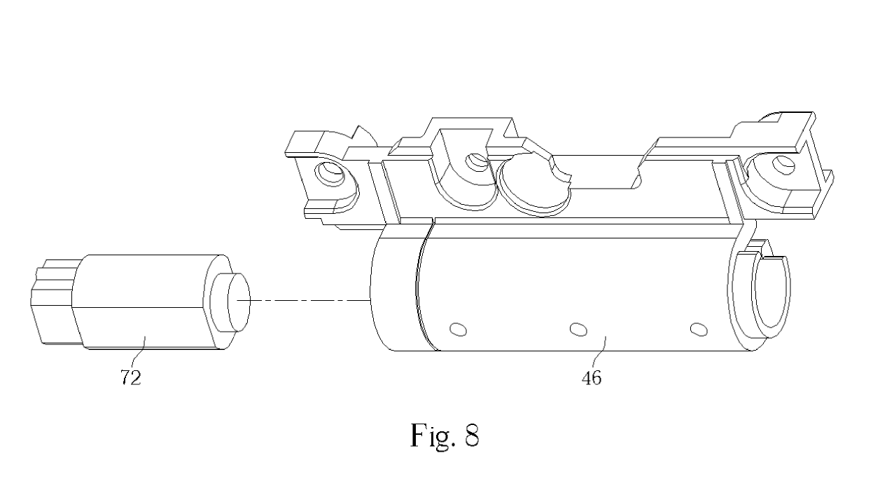

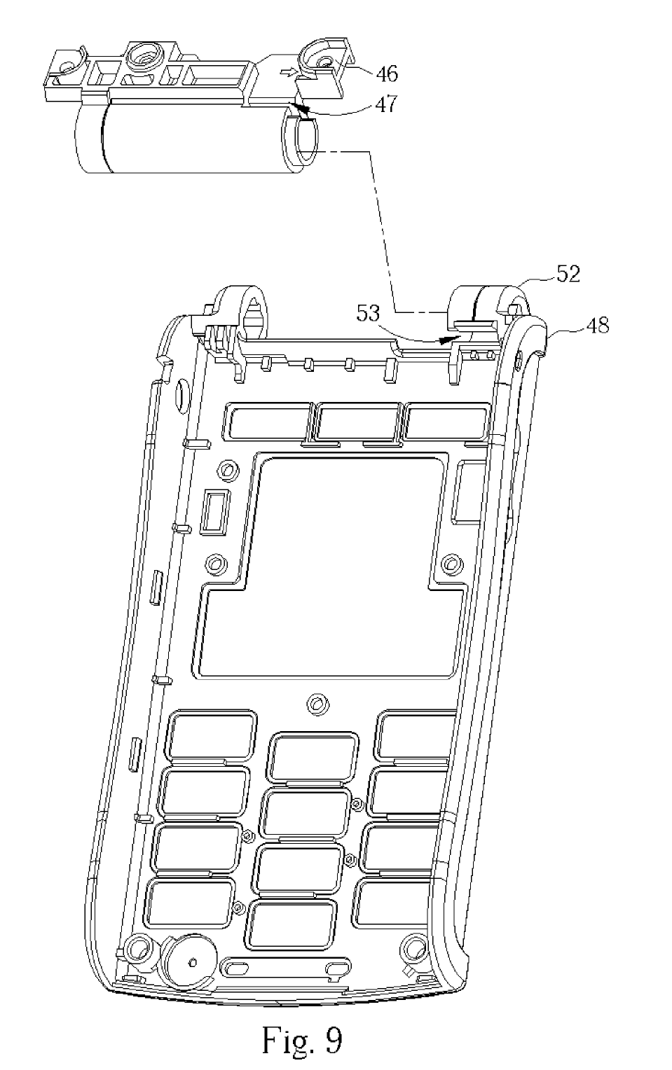

Please refer to FIG. 8 showing how to install the rotating axis 72 into the first rotating component 46, and FIG. 9 showing how to connect the first rotating component 46 to the second housing 48. The rotating axis 72 is tightly fitted into the first rotating component 46 from the end without the first slit 47 and passes through the first rotating component 46 in order to connect to the node on the upper left side of the second housing 48 in FIG. 9. The rotation moment of the first housing 42 and the second housing 48 is received by this node. The end of the first rotating component 46 with the first slit 47 is pressed into the second rotating component 52. Since this end is for installing the FPC 70, the rotating axis 72 is not installed in this end, for it may squeeze the FPC 70.

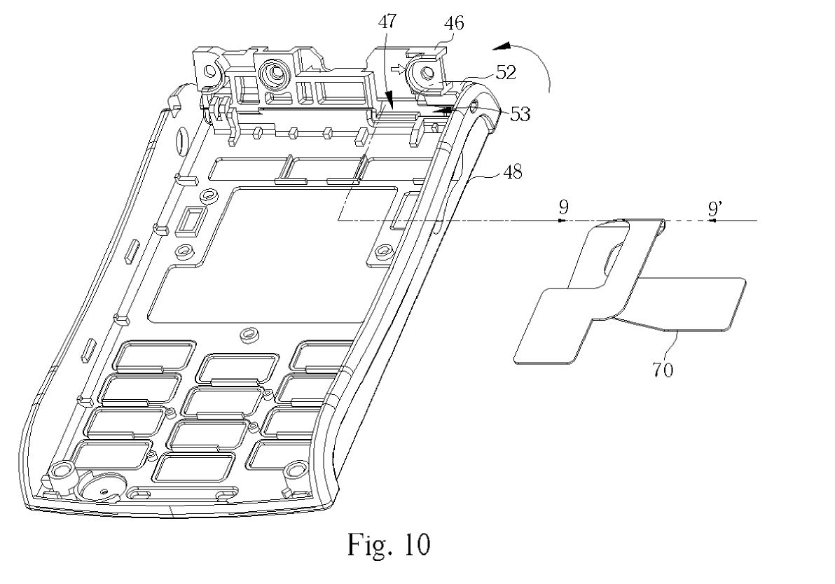

Please refer to FIG. 10 showing how to install the FPC 70 into the first slit 47 of the first rotating component 46 and the second slit 53 of the second rotating component 52. First, after the first rotating component 46 is assembled with the second housing 48, the first rotating component 46 is turned so that the first slit 47 of the first rotating component 46 and the second slit 53 of the second rotating component 52 are aligned with each other and form a single, longer slit. Then The FPC 70 is bended along the dashed line 9-9 as shown in FIG. 10 at an angle less than 360 degrees and installed into the first slit 47 of the first rotating component 46 and the second slit 53 of the second rotating component 52.

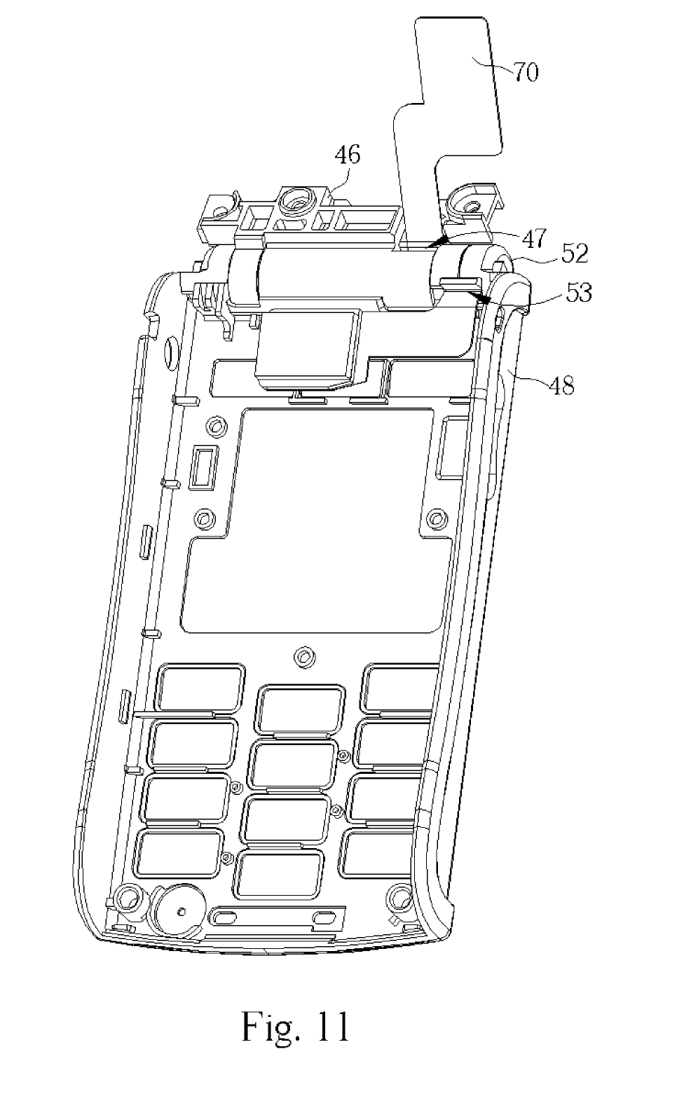

Please refer to FIG. 11 showing the first rotating component 46 rotated after installing the FPC 70 into the first slit 47 of the first rotating component 46 and the second slit 53 of the second rotating component 52. After installing the FPC 70 into the first slit 47 of the first rotating component 46 and the second slit 53 of the second rotating component 52, the first rotating component 46 is rotated so that it shows an angle of 155 degrees to the second housing 48, which is a typical angle when using the mobile phone 40. This angle can be fixed by a fixer.

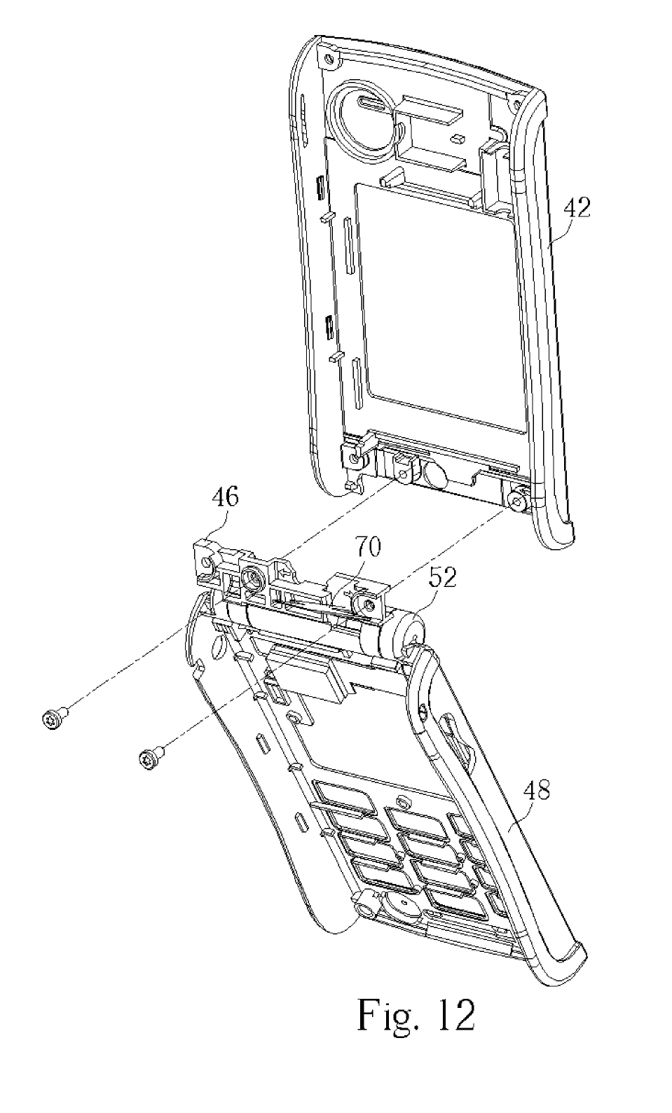

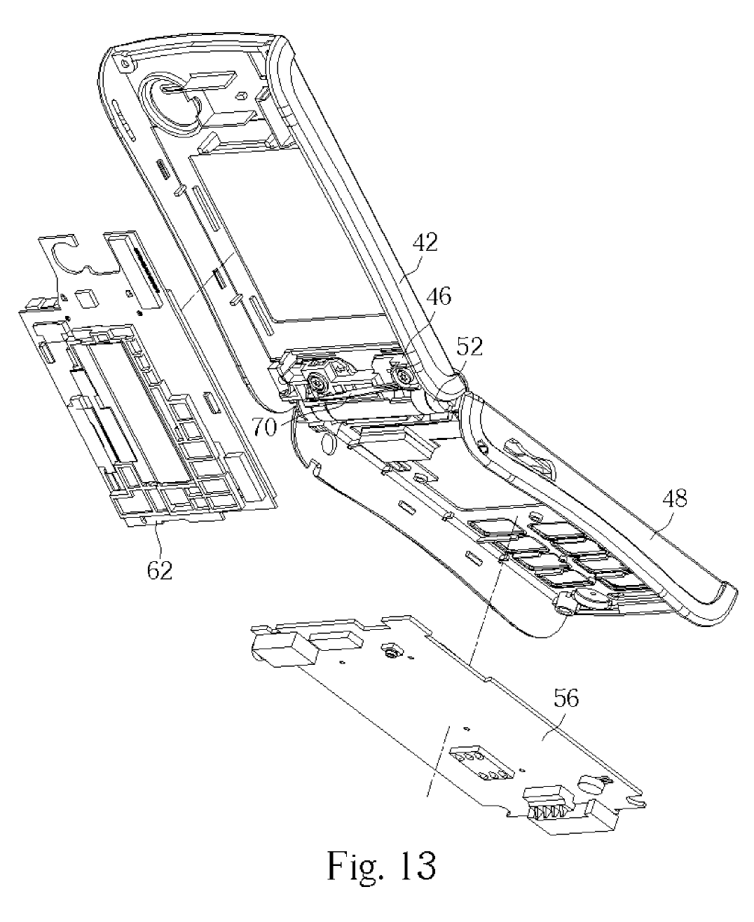

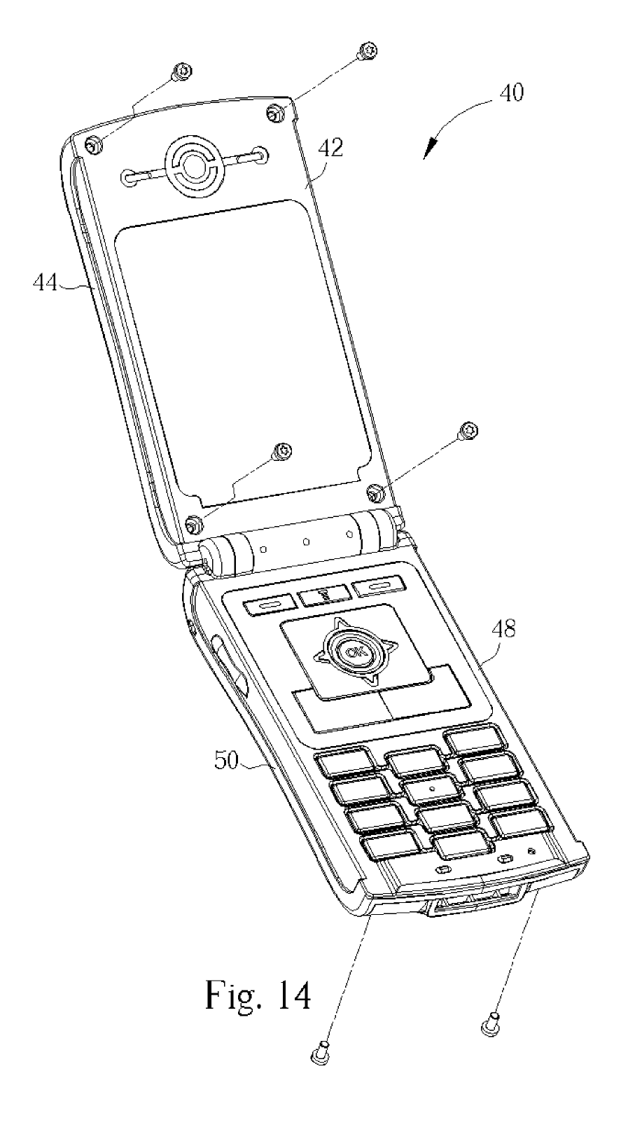

Please refer to FIG. 12 showing how to assemble the first housing 42 along with the first rotating component 46 to the second housing 48. The first rotating component 46 is screwed to the first housing 42. Please refer to FIG. 13 showing how to assemble the processing module 56 and the signal processing module 62 respectively to the second housing 48 and the first housing 42. After the first housing 42 and the second housing 48 is assembled, the processing module 56 and the signal processing module 62 are installed respectively onto the second housing 48 and the first housing 42. The first end of the FPC 70 is connected to the signal processing module 62 by male/female connectors, and the second end of the FPC 70 is connected to the processing module 56 by male/female connectors so that devices in the two modules can exchange signals and data with each other. Please refer to FIG. 14 showing all the housings of the mobile phone 40 assembled together. The first housing 42 is screwed with the third housing 44, and the second housing 48 is screwed with the fourth housing 50.

The slit for the FPC 70 of the present invention is covered by the housings so that it will not be exposed even when the hinge rotates. Those structures applying the same concept also belong to the present invention.

In contrast to the prior art, the present invention provides a structure covering the slit for the FPC 70 in the housings by rotating the rotating component. Such kind of structure substantially improves upon the prior art, which cannot be applied to a mobile phone with an exposed hinge, for the hole is also exposed when rotating the hinge. Moreover, the FPC 70 is installed in the mobile phone 40 at an angle less than 360 degrees so that it will not be overbended as in the prior art, and accordingly the possibility to be damaged can be reduced.

Those skilled in the art will readily observe that numerous modifications and alterations of the device may be made while retaining the teachings of the invention. Accordingly, the above disclosure should be construed as limited only by the metes and bounds of the appended claims.

1. A mobile phone comprising:
a first housing comprising a first rotating component with a first hole;
a display panel installed on the first housing;
a second housing comprising a second rotating component with a second hole and connected to the first rotating component, and a plurality of buttons installed on the second housing for inputting button signals;
a flexible printed circuit (FPC) with a first end stretching from the first opening and a second end stretching from the second opening;
a third housing connected to the first housing; and
a fourth housing connected to the second housing.

2. The mobile phone of claim 1 further comprising a signal processing module installed in the first housing and the third housing, and a processing module installed in the second housing and the fourth housing for controlling the operation of the mobile phone, wherein the signal processing module and the processing module are respectively connected to the first end and the second end of the FPC.

3. The mobile phone of claim 2 wherein when the first opening of the first rotating component and the second opening of the second rotating component are on the same level, the FPC can be installed in the first opening of the first rotating component and the second opening of the second rotating component, and when the first rotating component and the second rotating component are rotated, the first end of the FPC is connected to the signal processing module and the second end of the FPC is connected to the processing module.

4. The mobile phone of claim 3 wherein the FPC is folded and installed in the mobile phone at an angle less than 360 degrees.

5. The mobile phone of claim 2 wherein the display panel is electrically connected to the signal processing module for displaying data from the signal processing module as an image.

6. The mobile phone of claim 2 further comprising a speaker installed in the first housing and the third housing and electrically connected to the signal processing module for converting data from the signal processing module into real sound.

7. The mobile phone of claim 2 further comprising a vibrator installed in the first housing and the third housing and electrically connected to the signal processing module for vibrating the mobile phone when receiving vibration signals from the signal processing module.

8. The mobile phone of claim 2 further comprising a microphone installed in the second housing and the fourth housing and electrically connected to the processing module for converting real sound into audio signals and transmitting them to the processing module.

9. The mobile phone of claim 2 further comprising a radio module installed in the second housing and the fourth housing and electrically connected to the processing module for receiving radio signals to generate corresponding communication signals and transmitting them to the processing module, and outputting data from the processing module wirelessly.
